(19) United States
(12) Patent Application Publication
(10) Pub. No.: US 2008/0199660 A1
(43) Pub. Date: Aug. 21, 2008

(54) Embossing Roller, Embossing Device Including Said Roller and Paper Article Produced With Said Embossing Device

(75) Inventor: Mauro Gelli, Lucca (IT)

Correspondence Address: BREINER & BREINER, L.L.C., P.O. BOX 320160, ALEXANDRIA, VA, 22320-0160, US

(73) Assignee: Fabio Perini S.p.A., Lucca (IT)

(21) Appl. No.: 11/885,424

(22) PCT Filed: Feb. 27, 2006
(86) PCT No.: PCT/IT06/00112

§ 371 Date: Aug. 31, 2007

(30) Foreign Application Priority Data
Mar. 1, 2005 (IT) FI2005A0000033

(51) Int. Cl. B32B 3/28; B31F 1/07; B32B 37/12; B32B 37/00; B32B 29/00

(52) U.S. Cl. 428/172; 428/43; 156/384; 156/536; 156/513; 156/459; 428/211.1; 101/23

(57) ABSTRACT

The embossed or printed web material article comprises at least two plies (V1, V2) of tissue paper joined together by gluing and forming at least one multi-ply sheet. The sheet has a principal pattern (D), embossed or printed, in a substantially intermediate position with respect to the surface of the article, and secondary embossed or printed patterns (U, V) of smaller dimensions arranged along the edge lines of the article and interrupted by said edge lines. FIG. 3 schematically shows an axonometric view of the embossing roller (21). The cylindrical surface of which is indicated with 21S. Defined on the surface of the roller are annular i.e. circumferential areas or bands (21C), along which protuberances are arranged to define an embossing pattern, which will be referred to hereunder as circumferential secondary embossing pattern. A longitudinal band (21L) is also represented on the cylindrical surface of the embossing roller. In actual fact, several longitude bands are provided along the circular extension of the roller. As in case of the circumferential bands, protuberances defining an embossing pattern, which will be referred to hereinafter a longitude secondary embossing pattern, are also provided along the longitudinal bands.

### TECHNICAL FIELD

The present invention relates to innovations to devices for embossing web materials, and especially webs or sheets of paper, in particular tissue paper, to produce rolls of toilet paper, kitchen towels, paper napkins or similar products.

More specifically, the invention relates to improvements concerning the configuration of the embossing rollers and of the embossed product.

### STATE OF THE ART

In the production of rolls of tissue paper, or crepe or absorbent paper to form rolls of toilet paper, kitchen towels and the like, one or more plies of paper are usually subjected to an embossing operation, with which the paper material is permanently deformed to form thereon protuberances of various shapes. Embossing, which also causes localized breakage of the cellulose fibers forming the paper web, has a technical-function object, consisting in increasing the softness and volume of the finished product, together with its absorption capacity. However, embossing is also used to define limited areas, at the level of which a glue is applied to join together two or more plies forming the finished multi-ply product.

Besides the aforesaid technical functions, and others known to experts in the field of paper converting, embossing also has the object of providing the product with a pleasing aesthetic appearance, and in some cases also of characterizing the product of a specific manufacturer.

The technical and aesthetic functions have different requirements, which are often incompatible. The embossing patterns currently used must in the first place be compatible with the technical and functional requirements of the product but also of the machine that converts the material. This poses serious limits to the type of decoration obtainable with embossing. For example, the embossing pattern must take account of the fact that the glue, which guarantees joining of the plies, is applied to the protuberances obtained by deforming the material. As the plies must also be joined reliably along the cutting edges, the embossed patterns cannot be centered with respect to the finished product, leaving the perimeter areas free. Rather, they must extend right to the edges.

The embossed surface must then be distributed uniformly to obtain homogenous and stable gluing. Moreover, embossing machines or embossing units cannot accept any type of embossing pattern, as this has considerable effects on dynamic stresses. In fact, embossing is generally obtained by pressing a pressure roller coated in an resiliently yielding material against an embossing roller, generally made of steel or another rigid material, provided with embossing protuberances, and by feeding the material to be embossed into the nip between the two rollers. The rollers rotate at high speed. In modern paper converting lines the feed speed of the plies of paper exceeds 300 m/min and is typically around 500-600 m/min for the production of absorbent paper, while it can exceed 1000 m/min for the production of toilet paper, with a constant tendency of machinery manufacturers to reach increasingly higher speeds.

The embossing protuberances on the embossing rollers generate strong vibrations. The embossing pattern, in particular the distribution and dimension of the protuberances, has a considerable influence on dynamic phenomena in machines, to the extent that some embossing patterns are totally incompatible with correct operation of the embossing unit and of the entire line at the production speeds compatible with the current needs for high productivity.

In particular, the most critical phenomenon determined by the embossing protuberances is represented by the generation of vibrations in the machine caused by sudden variation of the contact surface between embossing roller and pressure roller, due to the fact that this contact surface is defined by the embossing protuberances, and consequently varies cyclically as the rollers rotate. To prevent or reduce these problems, EP 0,370,972 describes a specific arrangement of the protuberances of the embossing roller, which guarantees high operational constancy while reducing vibrations to a minimum. EP 0,370,972 describes an embossing device in which the tips are aligned according to multi-start helices. In the case of complex embossing patterns especially, according to this method it is particularly critical to calculate the pitch and inclination of the helices so that these are completed on the diameter of the embossing roller.

In some embossing devices, more complex arrangements of protuberances are also used, with background protuberances of small dimensions and high density, e.g. frusto-pyramid or frusto-conical protuberances, arranged according to helical alignments, with which protuberances or groups of protuberances forming decorations of larger dimensions are combined. These decorations are again arranged in helical alignments, so that contact between the embossing roller and the pressure roller is always gradual and uniform.

The result of these technical-functional constraints on the embossing protuberances is that in the finished roll of paper the embossed patterns are always arranged according to alignments inclined with respect to the edges of the paper and are usually of small dimensions. On a single sheet of paper delimited by two consecutive tear-off lines on a roll there are usually several individual decorations, arranged according to inclined alignments, corresponding to the helical alignments of the protuberances on the embossing roller.

Examples of embossing units, embossing incisions and relative embossed products are described in EP-A-1,075,387; EP-A-0,765,215; EP-A-408,248; U.S. Pat. No. 4,320,162; U.S. Pat. No. 5,686,168; EP-A-1,054,764; U.S. Pat. No. 4,978,565; U.S. Pat. No. 3,694,300; FR-A-2,684,598.

Although to a lesser extent, problems of vibrations due to the presence of raised areas on the surface of the rollers are also found in printing devices or units.

### OBJECTS AND SUMMARY OF THE INVENTION

According to a first aspect, the object of the present invention is to provide an embossed or printed sheet product, especially a roll of embossed or printed multi-ply tissue paper, or a folded napkin, which has high technical-functional characteristics, and which does not have the aesthetic limits mentioned above.

In substance, according to this first aspect, the invention provides for a roll of embossed or printed web material comprising at least two plies joined together by gluing or in another way, divided into a plurality of individual sheets separated by transverse perforation lines in which: each of said sheets has a principal decoration, such as a principal embossed or printed pattern, in a substantially intermediate position of said sheet; arranged along the longitudinal edges of said web material are secondary embossed or printed patterns of smaller dimensions, interrupted by the longitudinal edge lines; and further secondary embossed or printed patterns are produced overlapping the perforation lines.

Hereunder specific reference will be made to embossed materials, in which the patterns or decorations are obtained by embossing, but it must be understood that at least some of the advantages of the present invention can be applied also where the decorations or patterns are obtained by printing.

Moreover, in the various embodiments colored glues can be used to combine an embossing effect with a chromatic decorative effect.

The particular arrangement of the embossed or printed patterns according to the invention makes it possible to obtain a plurality of technical-functional and aesthetic effects of considerable emphasis. In fact, the secondary embossed patterns arranged along the longitudinal edges and along the transverse perforation lines have the function of allowing application of glue, if necessary also up to the edges of the web material of the roll and, if required, up to the level of the perforation lines. This can be important during production and use of the material, so that the final product is not subject to a flapping effect of the plies.

Moreover, from an aesthetic point of view, the secondary embossed patterns form a sort of frame surrounding a central decorative motif, which can also be large in size and formed by a plurality of protuberances combined with one another. This central decorative pattern does not require to be composed of repetitive decorative elements aligned in inclined directions with respect to the longitudinal edges of the web article.

With a distribution of embossed protuberances according to the invention, it is thereby possible, for example, to obtain a roll formed of sheets which can be torn off individually along perforation lines, in which each sheet comprises a large intermediate decoration, more or less centered on the sheet, surrounded by a frame which can be composed of geometrical elements or of patterns typically of substantially smaller dimensions with respect to the pattern forming the central decoration, in which the protuberances forming the decoration of the frame intersect the perforation lines and the longitudinal edge lines.

More generally, the invention relates to an embossed web material article (which can be a folded napkin, or a sheet of a roll of paper), comprising at least two plies of tissue paper joined together by gluing and forming at least a multi-ply sheet, characterized in that said sheet has a principal embossed or printed pattern, in a substantially intermediate position with respect to the surface of the article and secondary embossed or printed patterns of smaller dimensions arranged along the edge lines of the article and interrupted by said edge lines.

Advantageously, the two or more plies forming the article are glued together at protuberances forming the principal embossed pattern and the secondary embossed patterns along the longitudinal edges and preferably also at the protuberances forming the secondary embossed patterns along the perforation lines (when the article is in the form of a roll) or the transverse edges (when the article is in the form of a napkin).

Hereunder, specific reference will be made to characteristics and advantages of the embossed pattern according to the invention when applied to a product in a roll with perforation lines that divide it into individual tear-off sheets. Those skilled in the art will understand that at least some of these characteristics and relative advantages can also be applied In the case of articles composed of individual detached and folded sheets, such as napkins or the like.

According to an advantageous embodiment of the invention, the secondary embossed patterns and the principal embossed pattern are arranged and configured so that any straight line orthogonal to the longitudinal edges of the web material intersects at least one embossed protuberance of said principal embossed pattern and/or of said secondary embossed patterns.

In a possible embodiment of the invention, the secondary embossed patterns are arranged overlapping the perforation lines according to an alignment which is slightly inclined with respect to the respective perforation line, for example with an inclination between 0° and 30′ and 10° and preferably between 1° and 5° with respect to the direction of the perforation line.

The principal embossed patterns, which decorate each sheet into which the roll is divided by the perforation lines, can be the same as one another, or a sequence of different patterns, which are repeated along the extension of the roll, can be provided.

In an advantageous embodiment, the secondary embossed patterns arranged along the perforation lines are configured so that the position of the perforation line with respect to the secondary embossed pattern is not fixed. This allows a difference in phase between the secondary embossed patterns and the perforation line, without this having a negative influence on the overall aesthetic effect of the product. For example, the secondary embossed patterns can be composed of small rectilinear protuberances arranged according to short alignments variously inclined around and above the perforation line, so that the pattern is not characterized by a line of symmetry and the difference in phase between perforation line and embossed pattern is not perceivable by the person observing the product. This allows even significant differences in phase (the extent of which depends on the width of the secondary embossed pattern in a longitudinal direction) to be tolerated between the pattern and the perforation line.

Similarly, the secondary embossed patterns arranged along the longitudinal edges of the web material can also have, for the same purposes, a configuration in which the position of the edge line with respect to the secondary embossed pattern is not fixed.

According to a different aspect, the object of the present invention is to produce an embossing roller, which allows embossed products of high quality and aesthetic prestige to be obtained, without difficulties in the production phase.

According to this different aspect, the invention relates to a roller, for example a printing roller or preferably an embossing roller to print or emboss plies of web material, especially plies of paper such as tissue paper, comprising protuberances or raised areas defining embossing or printing patterns on the cylindrical surface of the roller, characterized by: a series of circumferential i.e. annular bands spaced apart by constant pitches, inside which a first secondary pattern is produced; a series of longitudinal bands, extending longitudinally along said roller, spaced apart by constant pitches, inside which a second secondary pattern is produced, said circumferential and annular bands defining squares inside each of which an intermediate principal pattern is produced.

With an arrangement of this type it is possible to emboss a ply (single or multiple) of tissue paper or the like, with a series of decorations placed side by side according to the transverse direction to subsequently produce, by cutting, a series of rolls each of which has an embossed pattern of the type defined above, with a principal intermediate pattern on each sheet surrounded by a frame pattern.

The arrangement of annular and longitudinal bands in combination with the principal intermediate embossed pattern in each square defined by the intersection of the annular and longitudinal bands allows the embossing protuberances to be arranged so as to obtain substantially continuous and uniform contact between the embossing roller and the pressure roller. This principle of distribution of the embossing patterns in fact allows a noteworthy number of protuberances along any generatrix of the roller, so as to reduce the generation of vibrations caused by variation of the contact surface of the embossing roller with a corresponding pressure roller.

Considering a generic generatrix of the cylindrical surface of the embossing roller (i.e. a straight line parallel to the axis and belonging to the ideal geometrical surface on which the front surfaces of the protuberances of the roller lie) said generatrix intersects a specific quantity of protuberances. Considering the sum of the lengths of the segments defined by each of these protuberances on the generatrix, particularly regular operation of the embossing unit incorporating a roller of this type is obtained when this sum fluctuates by less than 40%.

In a possible configuration, the longitudinal bands are parallel to the axis of the roller. Regularity of the contact between embossing roller and pressure roller is in any case guaranteed by the presence of the protuberances along the annular bands and of the protuberances defining the principal pattern. However, according to a modified embodiment, the longitudinal bands can advantageously be inclined with respect to the axis of the roller. In this case it is advantageous for the principal embossing patterns to be offset from one another, i.e. for the patterns arranged along an annular alignment to be offset with respect to those of the adjacent alignment. The inclination can be small, i.e. between 0° and 30′ and 10° and preferably between 1° and 5° with respect to the axis of the roller, i.e. with respect to a generatrix of the roller. The longitudinal bands are preferably inclined with a single or multiple V-shape. This arrangement has a guiding effect on the ply and can also have a widening effect.

The invention also relates to an embossing unit comprising an embossing roller of the aforesaid type and a paper converting line for producing rolls of toilet tissue, kitchen towels or the like, with an embossing unit equipped with an embossing roller of the aforesaid type.

Further advantageous characteristics and embodiments of the invention are indicated in the appended claims and will be described in greater detail hereunder with reference to examples of embodiment of the invention.

### BRIEF DESCRIPTION OF THE DRAWINGS

The invention will be better understood following the description and accompanying drawing, which shows non-limiting practical embodiments of the invention. More specifically, in the drawing:

FIG. 1 shows a diagram of a portion of a paper conversion line;

FIG. 2 shows a diagram of an embossing unit;

FIG. 3 shows a schematic axonometric view of the embossing roller;

FIGS. 3A and 3B show enlargements of some details in FIG. 3;

FIG. 4 shows three rolls obtained by cutting a single log produced with a production line incorporating an embossing roller according to the invention;

FIG. 5 shows portions of web material embossed according to the invention;

FIG. 5A shows enlargements of FIG. 5;

FIG. 7 shows a portion of web material in a roll similar to the embodiment in FIG. 5;

FIGS. 8 and 9 show an article in the form of a napkin, produced according to the teachings of the present invention; and

FIG. 10 shows a further article in the form of a napkin, produced according to the teachings of the present invention.

### DETAILED DESCRIPTION OF PREFERRED EMBODIMENTS OF THE INVENTION

The description below refers specifically to embossing rollers and patterns, but as mentioned above, at least some of the advantages attained by the invention are also useful in the printing field, especially to print multi-ply tissue paper products.

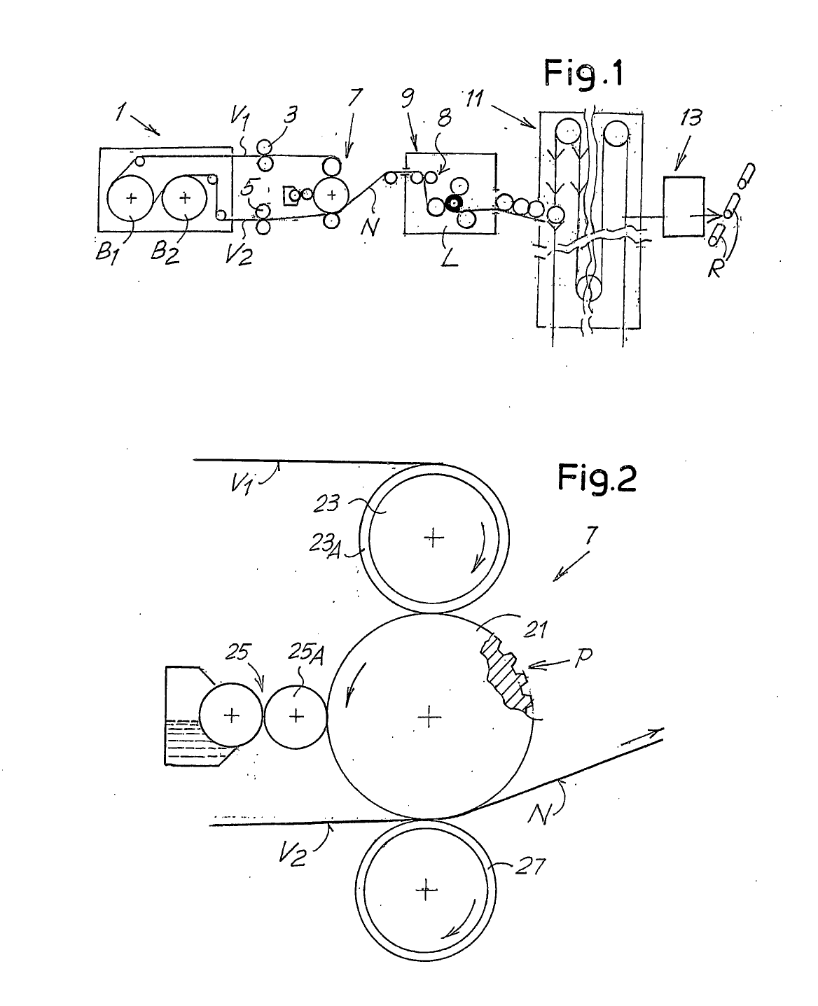

FIG. 1 schematically shows a portion of a line for converting tissue paper and producing rolls of toilet paper or kitchen towels. The line comprises an unwinder 1, in which two reels B1 and B2 of large diameter are unwound to feed the line. The plies fed from the reels B1 and B2 are indicated with V1 and V2.

Arranged along the feed path of the plies V1 and V2 are respective auxiliary embossing units 3 and 5, each of which can, for example, have a steel embossing roller and a pressure roller cooperating therewith. The auxiliary embossing units 3 and 5 can be designed conventionally and provided to impress background embossing on the two plies V1 and V2, for example micro-embossing composed of a fine geometrical pattern formed of truncated-pyramid shaped protuberances or the like. A pattern of this type can have a density of at least 10 protuberances/cm² or preferably of at least 15 protuberances/cm² and preferably between 30 and 90 protuberances/cm².

Each reel B1, B2 and therefore each ply V1 and V2 can in turn be composed of one, two or more layers. The reels B1 and B2 can also be replaced by a single two-ply reel.

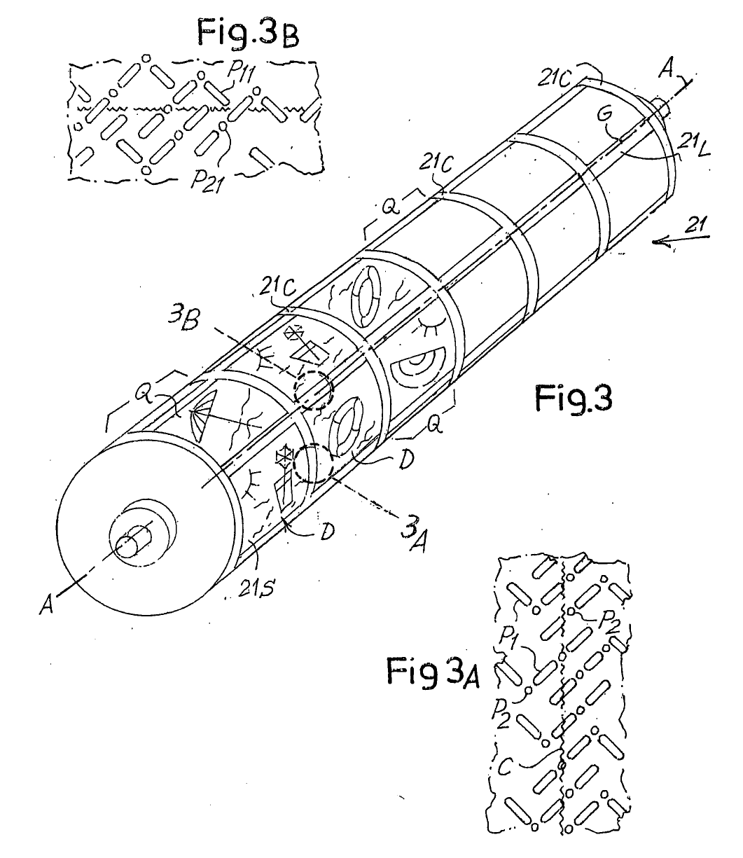

Arranged downstream of the auxiliary embossing units 3 and 5 is an embossing and laminating unit 7, the configuration of which is shown in greater detail in FIG. 2 and will be described hereunder. Upon delivery from the embossing and laminating unit 7 the two plies V1 and V2 form a single web article N, which is fed to a rewinding machine 9, of a type known per se and not described in greater detail. Associated with the rewinding machine 9 is a perforator 8 which makes, on the web material N, transverse perforation lines, equidistant from one another and substantially orthogonal to the direction of longitudinal feed of the web material N.

The rewinding machine 9 produces logs L of a diameter equivalent to the diameter of the finished rolls and a length equal to a multiple of the axial length of the rolls. The logs are accumulated in an intermediate storage unit or store 11 and from here are sent to one or more cutting machines 13 that divide the logs L into rolls R. The structure of the cutting machine is also known per se and will not be described herein. Other machines, not shown, such as one or more machines to glue the free tail end of the logs L, unless this gluing is perform directly inside the rewinding machine 9, can be arranged between the rewinding machine 9 and the cutting machine 13.

The embossing and laminating unit 7 includes an embossing roller 21 provided on the cylindrical surface thereof with protuberances, indicated here generically with P, the arrangement of which forms a specific object of the present invention and will be described in greater detail hereunder.

Cooperating with the embossing roller 21 is a pressure roller 23, the outer surface of which is defined by a layer 23A of resiliently yielding material, such as rubber. The pressure roller 23 and the embossing roller 21 are pressed against each other at high pressure, so that the protuberances P of the embossing roller 21 penetrate the smooth surface of the coating 23A of the roller 23 to deform it. The ply V1 is fed around the pressure roller 23 and into the embossing nip defined between the pressure roller 23 and the embossing roller 21, so as to be embossed with a pattern corresponding to the arrangement of the protuberances P. Some possible embossing patterns are described in greater detail hereunder with reference to the subsequent figures.

Arranged downstream of the embossing nip along the embossing roller 21 is a glue dispensing unit 25, with an applicator cylinder 25A, which applies a glue to the raised surfaces of the embossed ply V1, at the level of all or of some of the protuberances of the roller 21.

The ply V1 remains engaged with the cylindrical surface of the embossing roller 21 until it is downstream of a lamination nip defined by the embossing roller 21 and a lamination roller 27, which can be coated with a resiliently yielding material, preferably of greater hardness than the coating of the roller 23. The ply V2 is also fed into the lamination nip and is glued to the ply V1 at the level of the areas wet with glue. The web material N formed of the two plies joined together is delivered downstream of the lamination nip.

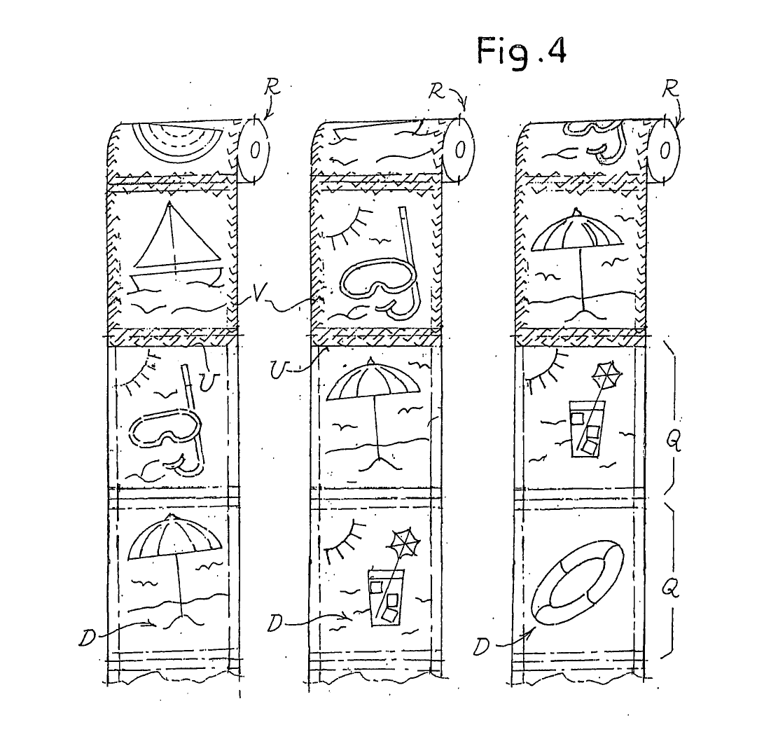

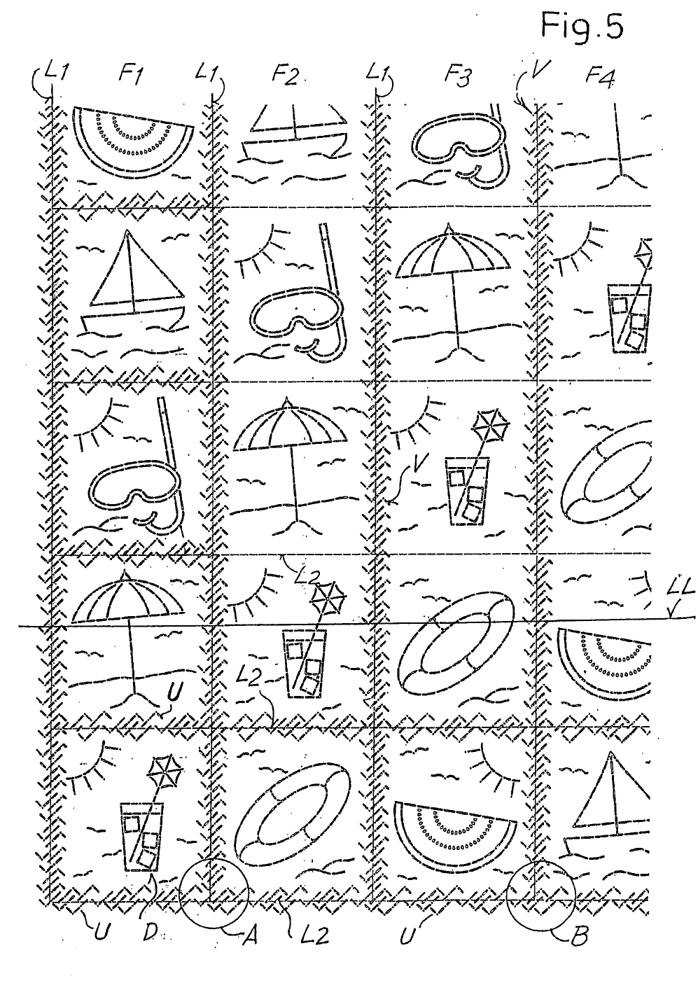

FIG. 3 schematically shows an axonometric view of the embossing roller 21, the cylindrical surface of which is indicated with 21S. Defined on the surface 21S of the roller 21 are annular i.e. circumferential areas or bands 21C, along which protuberances are arranged to define an embossing pattern, which will be referred to hereunder as circumferential secondary embossing pattern. The enlargement in FIG. 3A shows a possible conformation of this pattern. It is composed, in this example, of an alternation of protuberances P1, P2 respectively elongated and pointed in shape, arranged to form inclined and variously oriented alignments with respect to an ideal circular line, indicated with C, which corresponds, in the finished product, to a cut made by the cutting machine 13.

A longitudinal band 21L is also represented on the cylindrical surface 21S of the embossing roller 21. In actual fact, several longitudinal bands 21L are provided along the circular extension of the roller 21, all having substantially the same development and not visible in the axonometric view in FIG. 3. In this example, each longitudinal band 21L has a substantially V-shape with a very wide angle at the vertex. With the direction of rotation of the roller indicated by the arrow F in FIG. 3, this V-shaped arrangement of the protuberances defining the bands 21L has a transverse widening effect on the embossed material. As in the case of the circumferential bands 21C, protuberances defining an embossing pattern, which will be referred to hereinafter as longitudinal secondary embossing pattern, are also provided along the longitudinal bands 21L.

FIG. 3B shows a greatly enlarged view of an example of a pattern of this type. As can be seen in this enlargement, also in this case the pattern is formed of elongated protuberances P11 and of pointed protuberances P21. The protuberances are arranged so as to form variously inclined alignments with respect to a generatrix G, i.e. a straight line parallel to the axis A-A of the roller 21. The opposite inclination of the two portions into which each longitudinal band L is divided, and the width of said band are such that the generatrix G is contained fully in the width of the band 21L.

On the web material N the generatrix G coincides with a perforation line generated on said material.

The bands 21C and 21L define on the cylindrical surface 21S of the embossing roller 21 a series of squares Q, with more or less the same dimensions, inside each of which a raised pattern, generically indicated with D and hereinafter referred to as principal embossing pattern, is produced.

In practice, the longitudinal and inclined bands 21L can be formed by portions of band parallel to the axis A-A of the roller 21, at the level of each square Q, with the portions of subsequent squares offset from one another to obtain an overall V-shaped arrangement as described above. In this way, portions of band 21L parallel to the generatrix of the roller are obtained between two annular bands 21C. This arrangement is indicated schematically in FIG. 3. With this configuration, as will be apparent hereunder, rolls of web material are obtained, formed by a series of sheets separated by perforation lines included inside the embossed pattern generated by the protuberances arranged within the longitudinal bands 21L. In each sheet the portion of embossing in which the perforation line is contained is parallel to said perforation line.

Each principal embossed pattern D is formed by a series of protuberances varying in shape and dimension, arranged to form the decorative motif forming the pattern D. The various patterns D of the squares Q can be the same as or different from one another. As will be described with reference to specific embodiments, in each annular row of squares Q defined between two consecutive annular bands 21C, the patterns can be all the same, all different, or of two or three types alternated with one another along the extension of the annular alignment of squares Q. Moreover, some squares can be devoid of decoration D. The alignments of squares Q defined between adjacent annular or circumferential bands 21C can have the same or different patterns, with the same sequence in phase or with the same sequence but out of phase, as will be apparent hereunder.

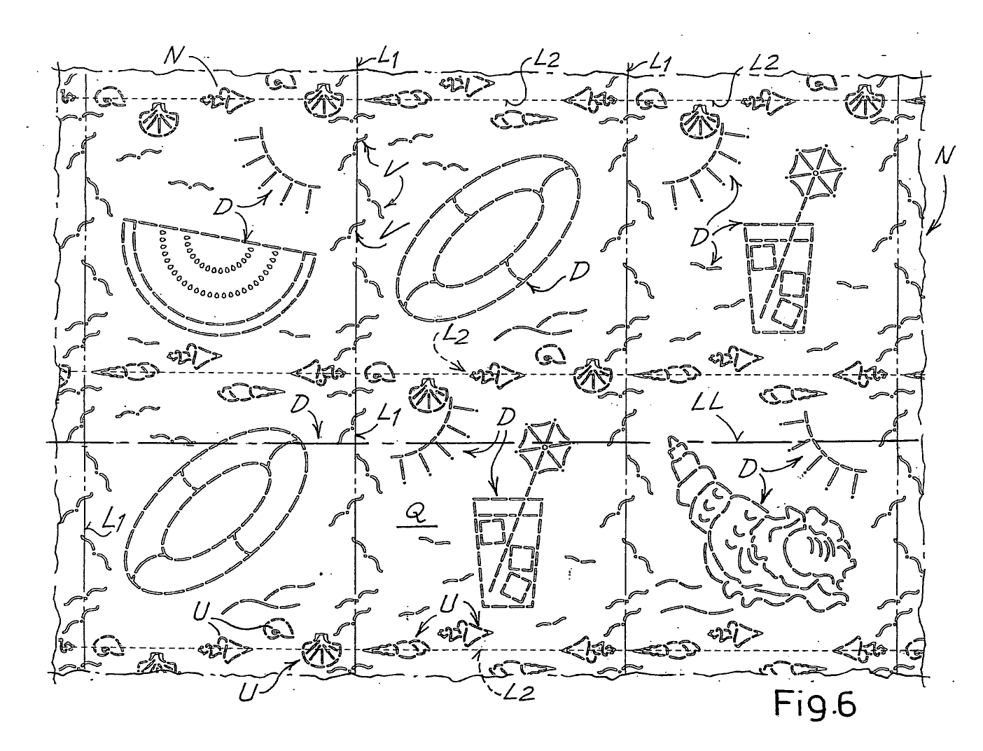

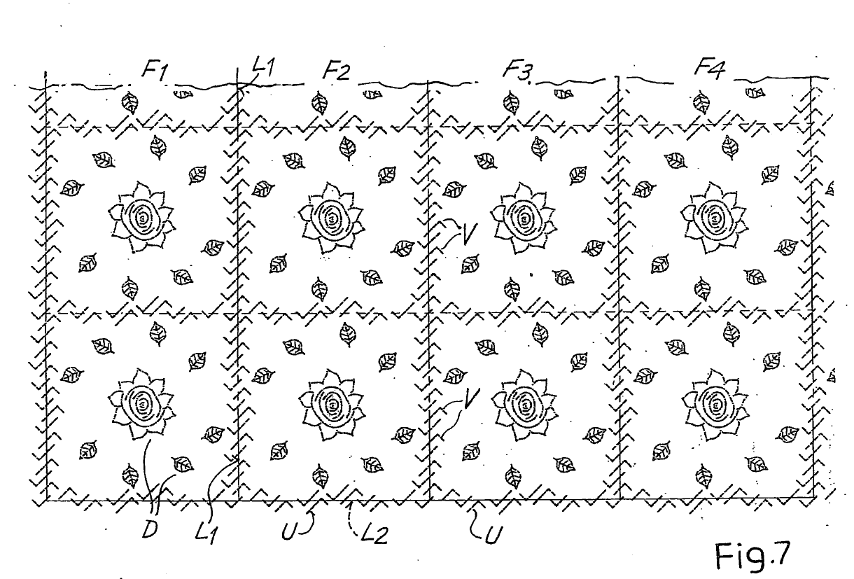

By embossing the ply V1 between the embossing roller 21 and the pressure roller 23 and subsequently joining it by lamination with the ply V2 in the lamination nip, a web product N is obtained with a width equal to a multiple of the axial length of the rolls R to be produced. FIG. 5 shows a portion of a web article N thus obtained with a possible example of embossed pattern, viewed from the exposed face of the ply V1. On the opposite face the pattern is less visible, as the lamination roller 27 does not emboss or only limitedly embosses the plies V1 and V2 during lamination. Naturally, it would also be possible to markedly emboss the web material N in the lamination nip as well.

With reference to FIG. 5, in the portion of web product N represented therein, it can be seen that the embossing roller has generated a series of bands F1, F2, F3 and F4 of decorations composed of principal embossed patterns D. In the example shown, five principal embossed patterns D, respectively representing (from bottom to top) a drinking glass, a beach umbrella, a snorkeling mask, a yacht, a slice of watermelon, are arranged in sequence in the band F1. The patterns are, obviously, to be considered as examples, it being understood that the specific appearance of these patterns is not limiting. The same motifs are reproduced in the band F2, offset by one step, i.e. by one square, the motif in the lower position in this case being a life buoy, which is also present in the top portion of the band F1, not represented. In the band F3 the same patterns as the band F1 are again reproduced, offset by two steps, i.e. by two squares, with the bottom square containing the pattern of the slice of watermelon and the second square from the bottom representing the life buoy. The band F4 represents the same patterns or motifs offset by a further step or square.

The bands F1-F4 are separated from one another by longitudinal secondary embossed patterns indicated with V, formed by the protuberances of the annular or circumferential bands 21C on the surface of the roller 21. Represented inside the longitudinal secondary embossed patterns are straight cutting lines L1, at the level of which the cutting machine 13 will cut the web material N after it has been wound in logs. The lines L1 therefore represent the edges of the material that will form the individual rolls into which the material N will be cut by the cutting machine 13. The width of the longitudinal secondary embossed patterns, corresponding to the width of the circumferential bands 21C of the roller 21, is such that the cutting line L1 falls inside the band even in the case of an error in positioning the logs L during cutting in the cutting machine 13. The configuration of the longitudinal secondary embossed pattern is such that the final user of the product does not perceive any slight offset between the line L1 and the band of the longitudinal embossed pattern, as the longitudinal secondary embossed pattern has no median line of symmetry or, in any case, a symmetry to be complied with.

The lines L2 represent the perforation lines, orthogonal to the lines L1. These perforation lines L2 are generated by the perforator 8 on the web material N and are in phase with the bands of a transverse secondary embossed pattern, generated by the bands of longitudinal protuberances 21L. The secondary embossed pattern along the lines L2, indicated with U, is only partly shown for simplicity of the drawing, but it must be understood that this pattern is produced along all the perforation lines L2.

FIG. 5A shows enlargements of two areas A and B in FIG. 5, reproduced side by side. By comparing these two enlarged portions it can be seen that the perforation line L2 is not parallel to the band of the transverse secondary embossed pattern, as the longitudinal bands 21L of protuberances that generate this secondary embossing are not parallel to the generatrix of the embossing roller 21, but are formed by single segments each parallel with the axis of the roller, but offset from one another to obtain an overall V-shaped arrangement.

The configuration of the protuberances P21, P11 which form the embossings of the transverse secondary embossed patterns is such that reciprocal offset between the embossed bands and the perforation line L2 is not perceived by the person observing the pattern of the finished product, the width of which is equal to the width of only one of the bands F1-F4.

The object of the overall inclination of the longitudinal bands 21L is to increase uniformity of contact between the embossing roller 21 and the pressure roller 23.

The principal embossed patterns D are formed, as mentioned, by protuberances of various shape and dimension, compatible with the requirements of correct bonding and correct deformation of the cellulose material. The dimension of the individual principal embossed patterns is such that the pattern substantially occupies the entire square, coming close to the edge areas.

With a configuration of this type the following result is obtained. By tracing a generic straight line LL (FIG. 5 or 6) orthogonal to the lines L1 and parallel to the lines L2, it is seen that this line intersects a large number of protuberances along the transverse extension of the web material N. By translating the straight line LL along the longitudinal extension of the web material N, i.e. parallel to the lines L1, the number of protuberances intersected by the line varies, although to a relatively small extent, thanks to the dimension of the principal embossed patterns D in the squares Q, which occupy a high surface area of the respective squares, to the alternation of the patterns D which are out of phase in the individual bands, to the presence of the longitudinal secondary embossed patterns along the lines L1, and also to the inclination of the transverse secondary embossed patterns with respect to the lines L2.

The ideal straight line (geometrical line) LL which runs on the final web product N represents the ideal contact line between the rollers 21 and 23 during rotation thereof. Consequently, along this contact line there are always a large number of protuberances of the embossing roller 21 which penetrate the coating of the pressure roller 23, deforming it. This effect is obtained without a helical pattern being produced on the embossing roller 21, and without a repetitive motif with a helical trend being visible on the finished product.

On the contrary: it is understood,that the rolls obtained by longitudinal cutting along the lines L1 are characterized by individual sheets, each defined by two transverse perforation lines L2; each of which is decorated with a single wide principal embossed pattern D surrounded by a frame formed of longitudinal and transverse secondary embossed patterns.

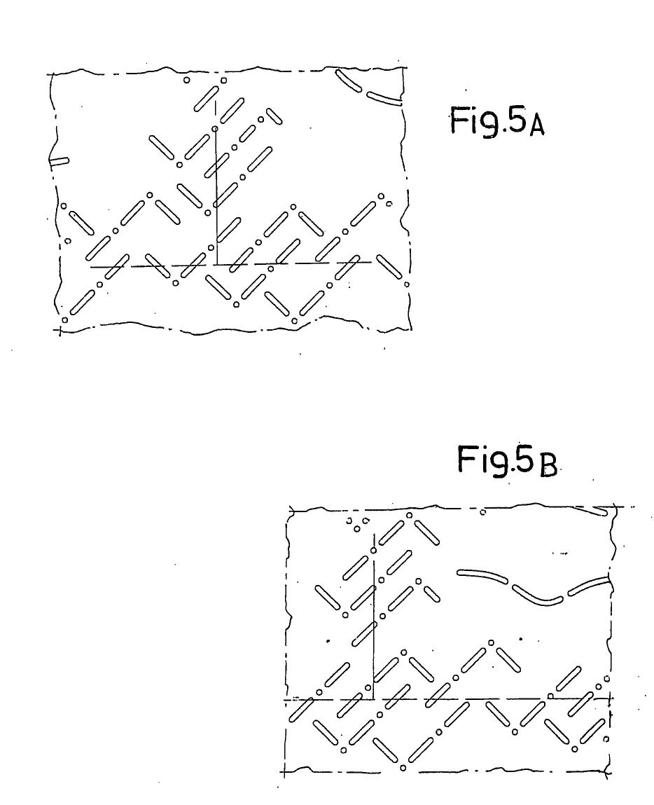

FIG. 4 schematically shows three partially unwound rolls, obtained by cutting the web material in FIG. 5.

In the example illustrated hereinbefore, geometrical embossed patterns have been produced along the perforation lines L2 and along the cutting lines L1, composed of a “disorderly” distribution of elongated and pointed protuberances. However, this is not the only solution to obtain the effects of the invention. In fact, it is possible to produce secondary embossed patterns representing a real subject, while maintaining the technical advantages and results illustrated above.

An example of an embossed pattern of this type is shown in FIG. 6. This shows six squares belonging to three separate longitudinal bands of a web material N which is to be cut, once wound in a roll, along the cutting lines L1. The web material N is perforated along the perforation lines L2. The principal embossed patterns D are represented by way of example by a slice of watermelon, a life buoy, a drinking glass and a shell, combined with other signs representing waves, birds, a sun, etc.

Secondary longitudinal embossed patterns represented by stylized flying birds, indicated with V and each formed of two elongated and undulated protuberances and one intermediate pointed protuberance, are produced along longitudinal bands containing the cutting lines L1. The protuberances defining these patterns intersect the lines L1 variably and not complying, for example, with a line of symmetry. Therefore, the line L1 can also be slightly offset with respect to the ideal position represented in the drawing. It remains within the band defined by the patterns V, intersecting them. The user of the finished product, composed of a single sequence of squares Q with alternation of the various decorations D will not perceive any offset between the secondary embossed patterns V and the longitudinal edge line of the product, represented by the cut performed along the line L1. All in all, therefore, the stylized birds formed by the protuberances along the lines L1 forming the motifs produced by the annular or circumferential bands of protuberances 21C form a first part of a frame which does not require to be perfectly centered (thereby guaranteeing a tolerance on the precision of the position to cut the log into rolls) and which, as in the stylized patterns of the example in FIG. 4, guarantee application of glue between the plies V1, V2 up to the very end of the longitudinal cutting line of the product.

Transverse secondary embossed patterns formed by sequences of protuberances representing stylized shells are produced along the perforation lines L2. Also in this case, as in the example in FIG. 4, the transverse secondary embossed patterns formed by the protuberances contained in the longitudinal bands 21L allow the plies V1 and V2 to be glued right up to the perforation line L2. This can also be offset, for example, due to inexact synchronization between the perforator 8 and the embossing unit 7, or due to the effects of elastic elongation of the paper along its path caused by possible fluctuations in tension. In any case, the width of the band containing the transverse secondary embossed patterns formed by the motifs U is such that the perforation line L3 falls within said band, and the patterns are such that the person using the finished product does not perceive any misalignments of the perforation lines.

As in the example in the previous FIG. 5, also in this case it is possible to trace a straight line LL parallel to the lines L2 and orthogonal to the lines L1, which intersects, along the transverse extension of the material N a large number of protuberances, belonging either to the secondary embossed patterns or to the principal embossed patterns inside the squares Q. The quantity and distribution of the intersected protuberances does not change substantially by translating the straight line LL along the longitudinal direction (i.e. parallel to the lines L1) of the web material N. This means that by moving the ideal contact line between the rollers 21 and 23 during rotation thereof, the contact and pressure areas (represented by the protuberances intersected by the line LL), remain more or less equal in number and distributed randomly and uniformly along the width of the machine, i.e. along the axial length of the rollers. This is true (in this case) even though the bands containing the lines L2 are exactly parallel to the axis A-A of the embossing roller 21. The presence of protuberances even along the entire width of the roller also guarantees relatively uniform wear of the rubber or other yielding coating of the pressure roller, as there are no annular lines devoid of protuberances.

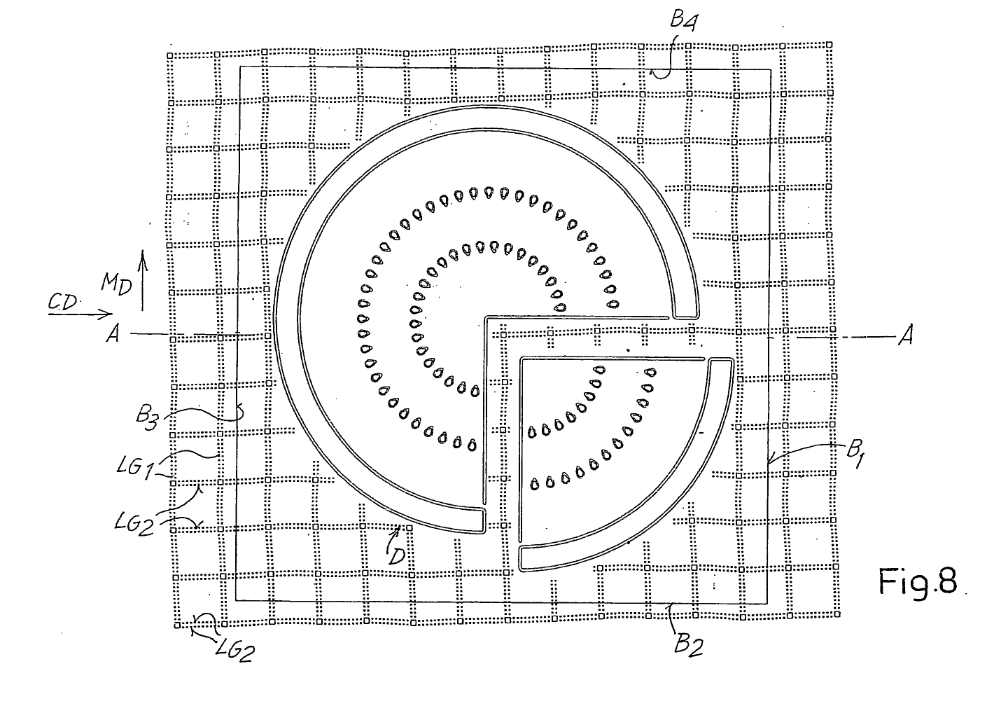

FIG. 7 shows a portion of a web material with a different embossed pattern produced following the same principle. The same numbers indicate parts, which are the same as or equivalent to those in FIG. 5. Along the cutting lines L1 which will separate the individual rolls, and along the perforation lines L2 which separate the individual sheets of a roll analogous patterns to those in FIG. 5 are produced, while in the squares thus formed, each of which represents a sheet of the finished product, floral decorations D are produced. The same numbers indicate elements that are the same as or equivalent to those in the previous figures. Considering a single perforation line L2, it can be seen that the embossed patterns produced overlapping this line are offset by a very small step, for example one millimeter, passing from one band of decorations to the other, for example from the band F1 to the band F2. In this way, in the finished product the secondary embossed decoration produced along the perforation line is substantially parallel thereto, while considering the overall width of the embossing roller and of the web material before the cut along the lines L1, the decoration along the lines L2 takes a V-shaped inclined trend, composed of individual portions defined between two consecutive lines L1, said portions being parallel to the axis of the roller, but each offset by one step with respect to the adjacent one.

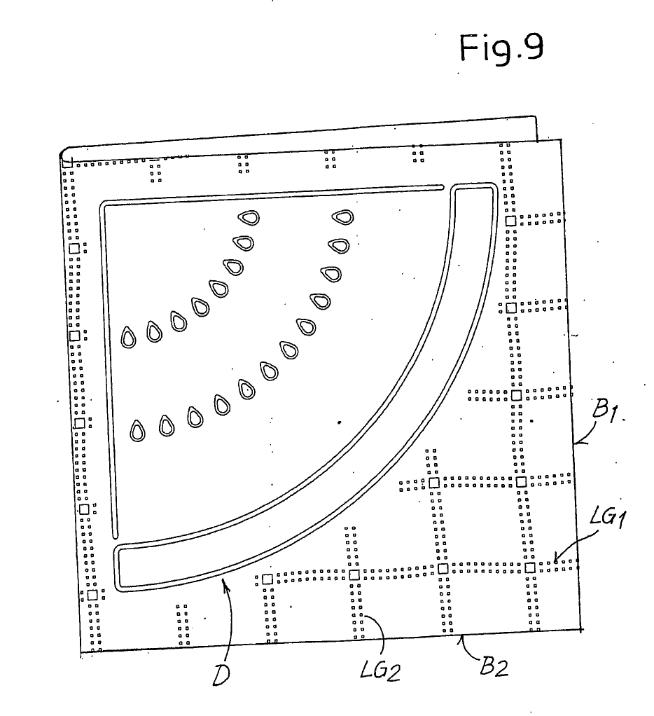

FIGS. 8 and 9 show an application of the invention to produce articles in the form of folded napkins or equivalent articles.

FIG. 8 shows a portion of an embossed web material spread out. B1, B2, B3 and B4 indicate the edge lines, along which, with known techniques, the material will be divided to form an individual napkin. In practice, the web material is composed of a pair of plies of tissue paper, embossed and glued, which are subsequently divided by longitudinal and transverse cutting lines into a plurality of sheet articles each delimited by edges along the lines B1-B4. MD and CD indicate the machine direction, i.e. the direction of feed of the web material in the embossing unit and the transverse direction, parallel to the axes of the rollers of the embossing unit. The embossing unit can be produced as described previously with reference to FIG. 2.

Produced over the entire extension of the web material are embossed lines, forming a more or less square grid or mesh motif. As can be seen in FIG. 8, the embossed lines LG2 have a longitudinal extension, substantially oriented according to the transverse direction CD, that is, according to the direction of the axis of the embossing roller. However, these lines are slightly inclined with respect to the direction CD and therefore not exactly parallel to the edges B2 and B4 of the finished product. Similarly, the embossed lines LG1 have a slightly inclined extension with respect to the machine direction, that is, with respect to the edges B1 and B3 of the finished product. The embossings forming the lines LG1 and LG2 form secondary embossed patterns, which are arranged along and overlapping the longitudinal and transverse edge lines B1-B4 of the finished product. The function of these secondary embossed patterns, and the arrangement thereof, is similar to that of the secondary embossed patterns U and V described with reference to FIGS. 5 to 7. Besides these functions, in the case of folded article the particular distribution of the embossed protuberances over the entire surface of the sheet forming the article allows the thickness to be made uniform, thereby facilitating packaging of a pile of folded articles.

Produced in the central area of the sheet defined by the edges B1-B4 is a decoration D, formed by embossed protuberances that form an ornamental or decorative motif, schematized in this case by a watermelon divided into two parts, with a slice detached from the rest of the pattern. The decoration D forms a complete motif formed by the two parts of a pattern, which complete one another. When the article formed by the sheet defined by the edge lines B1-B4 is folded in four, only one of the two portions forming the decoration D is visible on one of the exposed faces of said article, as shown in FIG. 9. Here the exposed portion is represented by the single slice of watermelon. In substance, the decoration D is formed of two parts of an image, which are combined to form a complete image, but one of which remains fully visible when the article is folded (FIG. 9), in turn forming a complete image.

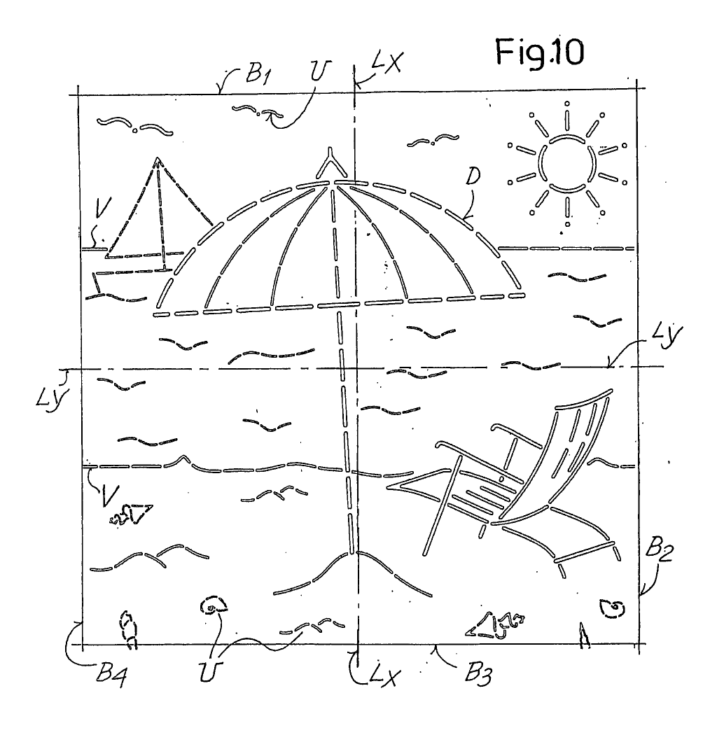

FIG. 10 shows an article in the form of a napkin or other article with a substantially square shape, to be folded in four along the two folding lines LX and LY indicated in Figure. The product is equipped with a principal embossed pattern, approximately centered with respect to the article, and composed in the example of a beach umbrella and a deck chair. As can be seen following the folding lines LX and LY, when the article is folded, one of the two elements (the deck chair) forming the principal embossed pattern (formed by combination of the two elements, deck chair and beach umbrella) is visible on the face that remains exposed. The effect obtained is similar to that of the pattern in FIGS. 8 and 9, although with two elements that are not part of each other (like the slice with respect to the fruit in FIGS. 8 and 9), but are two different and separate objects.

Extending along the edges indicated with B1, B2, B3 and B4 of the finished product are the secondary embossed patterns, having the functions already described, and namely to glue the plies forming the napkin up to the edges, and make contact between the embossing roller and the pressure roller continuous during production.

The concept used to produce the patterns in FIGS. 8, 9 and 10 can also be implemented with a different distribution of the secondary embossed patterns. Therefore, the invention also provides for an embossed web material comprising at least two plies of tissue paper joined by gluing and forming at least one multi-ply sheet, characterized in that said sheet has a principal embossed pattern, in a substantially intermediate position with respect to the surface of the article, said pattern comprising at least two portions, which form a complete decoration that can be observed when the article is opened, one of said portions in turn forming a different complete decoration, fully visible on a face of the article exposed when said article is folded.

It is understood that the drawing only shows possible embodiments of the invention, which may vary in forms and arrangements, without however departing from the scope of the concept on which the invention is based.

1-35. (canceled)

36. A roll of wound decorated web material comprising at least two plies of tissue paper joined together by gluing and forming at least one multi-ply web, wherein said roll is divided into sheets by perforation lines, said sheets have a principal pattern, in a substantially intermediate position with respect to a surface of the sheets, and secondary patterns of smaller dimensions arranged along edge lines of the sheets and interrupted by said edge lines, and wherein said secondary patterns of smaller dimensions overlap said perforation lines.

37. The roll as claimed in claim 36, wherein said principal pattern and said secondary patterns are embossed patterns.

38. The roll as claimed in claim 36, wherein each ply of said at least two plies has a grammage between 12 and 30 g/m².

39. The roll as claimed in claim 37, wherein each ply of said at least two plies has a grammage between 12 and 30 g/m².

40. The roll as claimed in claim 36, wherein said principal pattern in each sheet of said sheets is arranged in a substantially centered position with respect to each sheet.

41. The roll as claimed in claim 37, wherein said principal pattern in each sheet of said sheets is arranged in a substantially centered position with respect to each sheet.

42. The roll as claimed in claim 36, wherein said principal pattern on each sheet of said sheets is composed of an assembly of non-repetitive elements formed by a plurality of protuberances.

43. The roll as claimed in claim 37, wherein said at least two plies are glued together at a level of at least some protuberances which form the embossed patterns of the principal pattern and the secondary patterns.

44. The roll as claimed in claim 37, wherein said secondary patterns and said principal pattern are arranged and configured so that any straight line orthogonal to the edge lines of the web intersects at least one embossed protuberance of said principal pattern and/or of said secondary embossed patterns.

45. The roll as claimed in claim 37, wherein the secondary patterns overlapping the perforation lines are arranged inclined with respect to a respective perforation line.

46. The roll as claimed in claim 45, wherein said secondary patterns overlapping the perforation lines are inclined between 0°30′ and 10° with respect to a direction of the respective perforation line.

47. The roll as claimed in claim 45, wherein the secondary patterns are inclined with respect to the perforation lines and said secondary patterns have a width such that the perforation lines are inside the secondary patterns.

48. The roll as claimed in claim 46, wherein the secondary patterns are inclined with respect to the perforation lines and said secondary patterns have a width such that the perforation lines are inside the secondary patterns.

49. The roll as claimed in claim 36, wherein said secondary patterns overlapping the perforation lines are arranged according to bands substantially parallel to a respective perforation line.

50. The roll as claimed in claim 36, wherein said sheets have a plurality of different principal patterns which are embossed and arranged according to a repetitive sequence.

51. The roll as claimed in claim 36, wherein the secondary patterns are embossed and arranged along the perforation lines are configured so that the perforation lines are positioned in a non-fixed manner in relation to a respective secondary embossed pattern.

52. The roll as claimed in claim 36, wherein the secondary patterns are embossed and arranged along longitudinal edges of the web and are configured so that the edge lines positioned with respect to a respective secondary pattern is not fixed.

53. A roller for processing plies of web material comprising raised areas defining embossing or printing patterns on a cylindrical surface of the roller, including a series of circumferential or annular bands spaced apart from one another, inside which a first secondary embossing or printing pattern is provided; a series of longitudinal bands, extending longitudinally along said roller, spaced apart by constant pitches, inside which a second secondary embossing or printing pattern is provided; said circumferential and annular bands defining squares inside each of which an intermediate principal embossing or printing pattern is provided; and wherein said longitudinal bands are inclined with respect to an axis of the roller.

54. The roller as claimed in claim 53, wherein said longitudinal bands are parallel to the axis of the roller.

55. The roller as claimed in claim 53, wherein said longitudinal bands are inclined with a single or multiple V-shaped pattern.

56. The roller as claimed in claim 54, wherein said longitudinal bands are inclined with a single or multiple V-shaped pattern.

57. The roller as claimed in claim 53, wherein said longitudinal bands are inclined between 0°30′ and 10° with respect to the axis of the roller.

58. The roller as claimed in claim 54, wherein said longitudinal bands are inclined between 0°30′ and 10° with respect to the axis of the roller.

59. The roller as claimed in claim 55, wherein said longitudinal bands are inclined between 0°30′ and 10° with respect to the axis of the roller.

60. The roller as claimed in claim 53, wherein the longitudinal bands include arranged portions, wherein each portion is parallel to the axis of the roller and is offset with respect to one another, said each portion being defined by an intersection of one of said longitudinal bands with said annular bands.

61. The roller as claimed in claim 53, wherein said principal embossing pattern is arranged in a substantially centered position inside a respective square of said squares defined by said circumferential and annular bands.

62. The roller as claimed in claim 53, wherein each principal embossing pattern is a non-repetitive pattern, formed by a plurality of protuberances combined with one another.

63. The roller as claimed in claim 53, wherein protuberances form the first secondary embossing pattern, and the second secondary embossing pattern and the principal embossing pattern are arranged and configured so that any generatrix of the cylindrical surface of the roller intersects a plurality of said protuberances.

64. The roller as claimed in claim 63, wherein a sum of segments of each generatrix delimited by the protuberances intersected by said generatrix on the roller is between 5% and 30% of total axial length of the roller.

65. The roller as claimed in claim 53, wherein the principal embossing pattern of two consecutive annular portions are circumferentially offset from each other.

66. The roller as claimed in claim 53, wherein the principal embossing pattern in at least some of the squares defined by the annular bands is different from one another.

67. The roller as claimed in claim 66, wherein the principal embossing pattern of two consecutive squares are circumferentially offset from each other, and wherein said two consecutive squares have a common sequence for the principal embossing pattern, the two sequences being angularly offset by at least one step corresponding to one square.

68. An embossing unit comprising a pressure roller, a glue dispenser and an embossing roller; said embossing roller including a series of circumferential or annular bands spaced apart from one another, inside which a first secondary embossing or printing pattern is provided; a series of longitudinal bands extending longitudinally along said roller, spaced apart by constant pitches, inside which a second secondary embossing or printing pattern is provided; said circumferential and annular bands defining squares inside each of which an intermediate principal embossing or printing pattern is provided; and wherein said longitudinal bands are inclined with respect to an axis of the roller.

69. A production line for producing an embossed web material of at least two plies joined together by embossing and gluing, comprising
at least a first feed path for a first ply and a second feed path for a second ply;
an embossing unit comprising at least one embossing roller, a pressure roller cooperating with said embossing roller and a gluing unit;
downstream of the embossing unit, a perforator to perforate the web material along lines substantially transverse to a longitudinal extension of the web material; wherein said embossing roller includes a series of circumferential or annular bands spaced apart from one another, inside which a first secondary embossing or printing pattern is provided; a series of longitudinal bands, extending longitudinally along said roller, spaced apart by constant pitches, inside which a second secondary embossing or printing pattern is provided; said circumferential and annular bands defining squares inside each of which an intermediate principal embossing or printing pattern is provided; and wherein said longitudinal bands are inclined with respect to an axis of the roller.

70. The production line as claimed in claim 69, wherein said perforator is synchronized with said embossing unit so that perforation lines generated by the perforator are included within a width of the longitudinal bands containing the second secondary embossing pattern.

71. The production line as claimed in claim 69, further comprising, downstream of the perforator, a rewinding machine to wind the embossed web material into logs, and downstream of said rewinding machine, a cutting machine, to cut each log into rolls according to cuts orthogonal to an axis of the logs, said cutting machine being synchronized with said embossing unit so that individual rolls are divided along cutting planes contained in the circumferential or annular bands.

72. A web material article decorated by embossing or printing, comprising at least two plies of tissue paper joined together by gluing and forming at least one multi-ply sheet, wherein said sheet has a principal pattern, in a substantially intermediate position with respect to a surface of the article, comprising at least two complementary portions, which are combined to form a first complete decoration image observable when the article is open, one of said two complementary portions in turn forming a second complete decoration image which is different from said first complete decoration image, fully visible on a face of the article exposed when said article is folded.
